(19) United States
(12) Patent Application Publication
(10) Pub. No.: US 2012/0315414 A1
(43) Pub. Date: Dec. 13, 2012

(54) COMPOSITE COMPONENT

(75) Inventors: Karl Wesch, Waldbrunn (DE); Jochen Schilling, Leimen (DE)

(73) Assignee: Henkel AG & Co. KGaa, Duesseldorf (DE)

(21) Appl. No.: 13/525,972

(22) Filed: Jun. 18, 2012

Related U.S. Application Data
(63) Continuation of application No. PCT/EP2010/061083, filed on Jul. 30, 2010.

(30) Foreign Application Priority Data
Dec. 18, 2009 (DE) 10 2009 054 999.4

(51) Int. Cl. B32B 1/04; B32B 3/00; B32B 1/06; B32B 3/04

(52) U.S. Cl. 428/34.1; 428/121; 428/189; 428/76

(57) ABSTRACT

A composite component (100) having a shell (200) at least locally peripherally delimiting a space (201), and having a structural component (300) to reinforce the shell (200), where the structural component (300) is arranged at least locally at a distance from a wall (202, 203, 204), determining the space (201), of the shell (200), where a structural material (101) is provided at least locally between the wall (202, 203, 204) of the shell (200) and the structural component (300), where the shell (200) comprises at least one free edge (206, 207), and where the structural component (300) extends at least locally over the free edge (206, 207) of the shell (200).

The invention relates to a composite component made up of a shell at least locally peripherally delimiting a space, and to a structural component having structural material that is provided at least locally between the shell and the structural component.

A composite component of this kind has applications in particular in the vehicle sector. The shell that is utilized is, for example, a sill, an A-, B-, or C-pillar, a transverse link, a steering knuckle, or another at least locally trough- or shell-shaped component that is, in particular, reinforced by means of a structural component and a structural material.

A component of the kind recited above is disclosed in DE 69533457 T2: a composite component encompassing an external structural part configured as a C-shaped rail, having an outer wall surface and an inner wall surface; an inner reinforcing part having substantially the same shape as the external structural part, having an outer wall surface and an inner wall surface, where said inner wall surface of said inner reinforcing part delimits a cavity in which a resin-based material layer is provided, the outer wall surface of said inner reinforcing part being bonded onto the inner wall surface of said structural part by means of said resin-based material.

In order especially to reduce cost and weight, efforts are made to manufacture such structural parts, which are usually made of metallic materials, with the least possible outlay of material. This material saving can, however, result in a decrease in the strength of the composite component.

An object of the invention is therefore to supply an improved composite component made up of at least one shell, a structural component to reinforce the shell, and a structural material.

This object is achieved by the features of Claim 1.

The advantageous embodiments of the invention are indicated by way of the dependent claims.

The basic idea of the invention is the use of a composite component having a shell at least locally peripherally delimiting a space, and having a structural component to reinforce the shell, the structural component being arranged at least locally at a distance from a wall, determining the space, of the shell, a structural material being provided at least locally between the wall of the shell and the structural component, and the shell comprising at least one free edge over which the structural component extends at least locally.

The shell can, in this context, be any component of, for example, a vehicle, in particular an A-, B-, or C-pillar, a steering knuckle, a windshield frame, or a sill. This shell at least locally peripherally delimits a space. A “space” is to be regarded, for example in the context of a shell configured as a trough-shaped component having a U-shaped sectioned view, as the region that, in the sectioned view, is delimited by the U-shape of the component. The shell can, however, also have, for example, an L-profile or can represent simply a planar component that delimits, with its surface as a wall, a space above or below.

The structural component is by preference arranged at least locally in the space, and is in contact with at least a wall or a portion of the shell in such a way that a reinforcement of the shell by way of the structural component can be enabled. By preference, the structural component is arranged at least locally at a distance from a wall, determining the space, of the shell, in such a way that the structural material can be provided between the two components, in particular in order to supply a connection and/or an energy transfer capability between the shell and the structural component.

As a rule, such shells comprise free edges. A “free edge” is to be understood for purposes of the present invention on the one hand as an end portion of a wall of the shell that is determined by an edge, but on the other hand also as an edge region that can also be of planar conformation, for example a portion or region of the shell that projects from a portion locally determining the space.

In the context of the present invention, the structural component is configured in such a way that it extends at least locally over a free edge of the shell. Because of this extension of the structural component over the free edge it is possible, for example because of the elevation of the contact surface between the structural component and shell, to enhance the reinforcement, and in particular a stiffening performance, of the structural component for the shell. In particular, the specific region between the structural component and shell in the region of the free edge can be equipped with a structural material; this immobilizes the structural component in this region on the shell. The covering need not extend over the entire edge, but instead can be designed and arranged in such a way that it is provided in regions in which large forces are transferred from the shell to the structural component, or is even provided with a reinforced wall thickness of the structural component; and in regions in which no or little energy transfer is to be expected, no covering is provided resp. only a covering having a lesser wall thickness of the structural component is provided.

A further advantage is that protection of the edges of the shell is supplied thanks to the covering by the structural component. Shells used in particular in vehicle construction are usually fabricated from a metallic material. Although the materials utilized may often have been subjected to a corrosion-protective treatment, the edges are often no longer protected as a result of processing steps, and are exposed to external influences. By supplying a capability for covering the edges by means of the structural component it is possible in particular to prevent corrosion of the shells and thus supply a protection capability for the shell. Here as well, the covering by means of the structural component can be designed as described above, in accordance with the influences and stresses that are acting. For example, a complete covering can be suitable on edges directly impinged upon by, for example, spray water or condensation; on edges arranged in concealed fashion, less of a covering or none at all may possibly be needed. A structural material that completely fills up the open space between the two components is by preference provided in the region of the covering between the structural component and the shell, so that a sealed covering can be supplied in order to further improve the protection capability for the edge.

Because load-bearing components, in particular, in vehicles must often handle large forces and are moreover exposed to a wide variety of weathering influences, a combination of the advantages recited above is preferably selected. The structural component is therefore preferably designed in such a way that by means of the structural component, the edges are covered in such a way that on the one hand the above-described stiffening performance and/or reinforcing performance of the structural component for the shell can be supplied, in order to obtain a reinforced composite element. On the other hand, the covering is provided in such a way that a protection capability can be supplied in particular for edges stressed by external influences, for example in order to obtain a more corrosion-resistant composite component. It is thus possible, in the context of external applications such as, for example, subframes, transverse links, or other attached parts in vehicle construction, also to reduce the influence of aging as a result of environmental conditions.

The structural component is manufactured by preference from a plastic material. Known polyolefins such as PE or PP, PVC (soft or hard), ABS, PC (in particular transparent), polyamides (in particular PA 6, PA 6.6, PA 4.6), plastics having fillers (in particular glass fiber, glass beads, V0, mineral substances), TPE, TPU, or PS can be utilized, in particular, as materials. The use of a polyamide, in particular PA 6.6, has proven particularly advantageous as a substance for the structural material. The structural component can moreover in turn be a composite component, and in particular can be designed in fiber-reinforced fashion. The use of a polyamide having a proportion of up to 60% glass fibers has proven advantageous in this context. Particularly preferably, the glass fiber proportion is in the range between 15% and 35%.

A structural component having a high modulus of elasticity is preferably used. The structural component preferably has regions of differing strength. Regions of the shell at which particularly high loads are expected can be reinforced by means of the structural component with a large thickness; at less highly loaded regions of the shell, the thickness of the structural component can be made to be less, in particular in order to economize on material.

A further advantage is the use of a structural component made of a fiber-reinforced plastic. The use of a fiber-plastic composite as a material for the structural component allows a high specific stiffness and strength to be achieved so that, in particular, a structural component suitable for lightweight structural applications can be supplied. The reinforcing fibers used are, in particular, inorganic reinforcing fibers such as, for example, basalt fibers, boron fibers, glass fibers, ceramic fibers, or also silicic-acid fibers. Also conceivable are metallic reinforcing fibers, for example steel fibers. The use of organic reinforcing fibers such as, for example, aramid fibers, carbon fibers, polyester fibers, nylon fibers, or polyethylene fibers may also prove useful. Also conceivable is the use of renewable reinforcing fibers, of natural fibers, for example flax fibers, hemp fibers, or sisal fibers.

A further advantage is the use of a structural component made of metal, for example steel, aluminum, magnesium, or also a steel braid. The use of such a structural component is suitable in particular for reinforced composite component in which stringent requirements exist in terms of stiffness and strength. The use of coated and/or painted metal may be advantageous in order to protect the structural component from external influences.

Attachment of the structural component to the shell can furthermore be accomplished by bonding in via the structural material. Clips or slip-on fasteners, as well as corresponding receptacles or corresponding components, can furthermore be provided additionally or alternatively on the structural component and/or on the shell. Connecting means made of a metallic material, such as e.g. metal tabs, are also conceivable, so that the structural component can be connected to the shell via a welding method. Further conceivable connecting capabilities for the structural component and shell are clamping by means of attached clamping ribs or clamping nubs.

The structural material used has by preference a compressive strength in the range from 5 MPa to 40 MPa; structural materials in the range from 10 MPa to 25 MPa are particularly preferred. The structural material furthermore preferably has a modulus of elasticity in the range from 300 MPa to 25,000 MPa, very particularly in the range from 500 to 1500 MPa. It has furthermore proven to be particularly advantageous to use thermally expandable structural foams as a structural material. Medium- to low-expansion foams are preferably used as structural materials that exhibit the necessary high strength and adhesion. Expanding foams have the advantage that interstices can be closed in order to compensate for production tolerances in the walls and the structural component. Maximum energy transfer can thus be ensured even in a context of production tolerances. Closing of the interstices further serves for corrosion protection of the components. A further advantage with the use of such foams is that strength properties are obtained over a wide temperature range extending above 80° C., further enhancing the utilization potential of a component according to the present invention.

The use of a thermally crosslinking foam as a structural material has proven advantageous. The expandable compound preferably contains at least the following components:
a) a resin (hereinafter also referred to as a “binding agent”) that crosslinks, at temperatures in the range from 120 to 220° C., with itself or with other constituents of the compound,
b) a blowing agent that reacts at a temperature in the range from 120 to 220° C. with an increase in volume or evolution of gas, and thereby increases the volume of the compound by at least 20%.

Suitable polymeric basic binding agents (“resins”) for the thermally expandable structural material are, for example, ethylene-vinyl acetate (EVA) copolymers, copolymers of ethylene with (meth)acrylate esters, which optionally also contain portions of (meth)acrylic acid polymerized in, statistical or block copolymers of styrene with butadiene or isoprene or hydrogenation products thereof. The latter can also be tri-block copolymers of the SBS, SIS type or their hydrogenation products SEBS or SEPS. In addition, the binding agents can also contain crosslinkers, adhesion promoters, tackifying resins (“tackifiers”), plasticizers, and further adjuvants and additives such as, for example, low-molecular-weight oligomers. To achieve sufficient blowing capability and expandability, these polymeric binding agents further contain blowing agents that are described below.

It is possible in particular to use an alternative binding agent system (“resin”) for the reactive expandable structural material based on epoxy resins and hardeners, as disclosed for example in WO 00/52086 or WO 2003/054069 as well as WO 2004/065485. Regarding those aspects relevant to the material, reference may be made to the aforesaid documents, the disclosure of which supplements in that regard the disclosure of the present Patent Application.

The reactive structural materials can furthermore contain usual adjuvants and additives such as, for example, plasticizers, rheology adjuvants, crosslinking agents, adhesion promoters, aging protection agents, stabilizers, and/or color pigments.

Alternatively, the use of a chemically crosslinking foam as a high-strength structural material is also conceivable. Foams that are self-expanding as a result of chemical reactions, foams that expand by exothermy and possibly suitable foaming agents, or foams that expand variably in terms of degree of foaming as a result of the delivery of air or another gas by means of known foaming technologies, are used in particular.

As is also usual in the context of existing structural materials, for example reinforcing compounds in accordance with the existing art, it is desirable for the structural material to foam up slightly, and thereby increase in volume, upon heating to the hardening temperature. A nonpositive engagement, effective on all sides, between the connecting element and the structural component resp. the walls is thereby achieved. It is therefore also preferred in the case of the subassembly according to the present invention that the structural material foam up upon heating to 100 to 200° C., and in that context increase in volume by approximately 30 to approximately 250%. Blowing agents that produce this effect are known to the skilled artisan from the existing art. Examples thereof are indicated below.

In order to allow the object of stiffening and/or absorption and/or damping in particular of the cavity between the walls to be achieved after curing, it is useful that the structural material utilized have a modulus of elasticity of at least 180 MPa. As the skilled artisan knows, this can be established by way of the nature and quantity of the hardeners and accelerators. Examples thereof are indicated below.

Those compounds that are known to the skilled artisan from the existing art for the stiffening of cavities in vehicle bodies are suitable as a thermal structural material. By preference, the structural material must contain at least the following constituents: at least one reactive resin, and at least one hardener and/or accelerator. To establish the desired expansion behavior, it is preferred that the structural material additionally contain at least one blowing agent.

The hardenable resin can be selected, for example, from: polyurethanes having free or blocked isocyanate groups, unsaturated polyester/styrene systems, polyester/polyol mixtures, polymercaptans, siloxane-functional reactive resins or rubber, benzoxazine-based resins, and resins based on reactive epoxy groups.

For weight reduction, the structural material preferably contains, in addition to the aforesaid “normal” fillers, so-called lightweight fillers, which are selected from the group of the hollow metal spheres such as, for example, hollow steel spheres, hollow glass spheres, fly ash (fillite), hollow plastic spheres based on phenol resins, epoxy resins or polyesters, expanded hollow microspheres having a wall material made of (meth)acrylic acid ester copolymers, polystyrene, styrene/(meth)acrylate copolymers, and in particular of polyvinylidene chloride as well as copolymers of vinylidene chloride with acrylonitrile and/or (meth)acrylic acid esters, hollow ceramic spheres, or organic lightweight fillers of natural origin such as ground nut shells, for example the shells of cashew nuts, coconuts, or peanuts, as well as cork flour or coke powder. Particularly preferred in this context are those lightweight fillers, based on hollow microspheres, that ensure, in the cured shaped-element matrix, high compressive strength in the shaped element.

In a particularly preferred embodiment, the compositions for the thermally hardenable structural material additionally contain fibers based on aramid fibers, carbon fibers, metal fibers (made, for example, of aluminum), glass fibers, polyamide fibers, polyethylene fibers, or polyester fibers, these fibers by preference being pulp fibers or staple fibers that have a fiber length between 0.5 and 6 mm and a diameter from 5 to 20 μm. Polyamide fibers of the aramid fiber type, or also polyester fibers, are particularly preferred in this context.

The use of a structural adhesive as a structural material can alternatively prove advantageous. Both one- and two-component structural adhesives are conceivable here. The structural material used can also, however, be a one-component system that contains epoxy resins and activatable or latent hardeners.

These structural materials can furthermore be formulated as single-component pre-gellable adhesives; in the latter case, the compositions contain either finely particulate thermoplastic powders such as, for example, polymethacrylates, polyvinylbutyral, or other thermoplastic (co)polymers, or the hardening system is adjusted so that a two-stage hardening process takes place, such that the gelling step effects only partial curing of the adhesive, and final curing takes place during vehicle construction, e.g. in one of the paint ovens, by preferences in the cathodic dip oven.

The structural material compositions can furthermore contain usual further adjuvants and additives such as, for example, plasticizers, reactive diluents, rheology adjuvants, crosslinking agents, aging protection agents, stabilizers, and/or color pigments.

The following can be used, in particular, as a structural material matrix:

In accordance with WO 00/37554, compositions that contain
A) a copolymer having at least a glass transition temperature of −30° C. or lower and groups reactive with respect to epoxies, or a reaction product of said copolymer with a polyepoxide, and
B) a reaction product of a polyurethane prepolymer and a polyphenol or aminophenol, and
C) at least one epoxy resin.
   More detailed information with regard thereto may be gathered from the aforesaid WO 00/37554.

In accordance with WO 01/94492, compositions containing
A) at least one epoxy resin having an average of more than one epoxy group per molecule,
B) a copolymer having a glass transition temperature of −30° C. or lower and groups reactive with respect to epoxies, or a reaction product of said copolymer with a stoichiometric excess of an epoxy resin in accordance with A)
C) a latent hardener, activatable at elevated temperature, for component A), and either
D) a reaction product that can be manufactured from a difunctional amino-terminated polymer and a tri- or tetracarboxylic acid anhydride, characterized by on average more than one imide group and carboxyl group per molecule, or
E) a reaction product that can be manufactured from a tri- or polyfunctional polyol or a tri- or polyfunctional amino-terminated polymer and a cyclic carboxylic acid anhydride, the reaction product containing on average more than one carboxyl group per molecule, or
F) a mixture of the reaction products in accordance with D) and E).
   More detailed information with regard thereto may be gathered from the aforesaid WO 01/94492.

In accordance with WO 00/20483, compositions containing
A) a copolymer having at least a glass transition temperature of −30° C. or lower and groups reactive with respect to epoxies,
B) a reaction product that can be manufactured by reacting a carboxylic acid anhydride or dianhydride with a di- or polyamine and a polyphenol or aminophenol,
C) at least one epoxy resin.
   More detailed information with regard thereto may be gathered from the aforesaid WO 00/20483.

In the context of the use according to the present invention as a structural material, the adhesive utilized is thermally hardened, after connection of the components of the subassembly, for example at a temperature in the range from 120 to 200° C. for a time period in the range from 30 to 120 minutes. Hardening can be carried out in particular for a time period in the range from 50 to 70 minutes at a temperature in the range from 110 to 130° C.

The use of a material as described in International Patent Application PCT/EP2007/008141 may also prove useful. For those aspects relating to the material, reference may be made to the aforesaid document, the disclosure of which supplements, in that regard, the disclosure of the present Patent Application.

Activation and expansion of the expandable structural material can occur by preference by exploiting the process heat of a cathodic dip oven for curing the cathodic dip coating of, for example, a motor vehicle body. Separate application of heat in order to expand the expandable material is of course also conceivable.

A further advantage is application of the structural material onto the structural component by means of an injection molding method. The preferably expandable structural material is, in that context, injection molded onto the connecting element, made of a metallic material or a plastic material, during an injection molding operation. By preference, all structural materials being used are applied in one injection molding operation in order to economize on time and cost. The use of an injection molding method for application of the structural materials allows them to be applied precisely onto the intended locations on the structural component. In addition, metering of the quantity of structural material is simple, so that not too much material (which would increase costs) or too little material is applied. Alternatively, the structural material can also be applied onto the structural component by means of a pump method, for example automatically using a robot.

Manufacture of the structural component, and equipping it with structural materials, by means of a part-joining injection molding method and/or bi-injection molding method has proven particularly advantageous in the context of manufacturing the carrier from a plastic material. In a first step, the structural component itself, with possible receptacles for the structural material and/or connecting means for positional retention and/or optionally further constituent features, can be manufactured by injecting a thermoplastic material, in particular a polyamide, into an injection mold. The two halves of the injection mold are then pulled apart for unmolding. A plurality of structural materials, in particular made of a thermally expandable material, can then be applied in a second suitable injection mold in a second working step. With this kind of (preferably entirely automated) manufacturing method for a structural component with structural material according to the present invention, a structural component with structural material designed exactly for the shell to be reinforced can be made available with small production tolerances.

A further advantage is the use of a reinforced composite component such that at least one wall, determining the space, of the shell comprises a free edge. In particular in the context of arrangement of the structural component at least locally within the space, the stiffening performance of the structural component can be enhanced by means of the at least local covering of one edge by the structural component.

A further advantage is the use of a reinforced composite component such that the structural component extends in wraparound fashion over the free edge of the shell in order to completely cover the latter at least locally. The wraparound allows, on the one hand, particularly good capability for protection of the edge by the structural component to be supplied. On the other hand, the stiffening performance of the structural component can be further enhanced by the wraparound. The structural component is by preference configured in this context in such a way that the edges of the side walls of the shell are covered by the wraparound of the structural component. It may prove useful in this context that the wrapping-around region of the structural component is capable of substantially completely covering the entire height of a wall, i.e. of a side flank of the shell, both internally and externally.

A further advantage is the use of a reinforced composite component such that the wraparound region of the structural component is arranged at least locally at a distance from the free edge, a structural material being provided at least locally between the structural component and the free edge. This allows, in particular, complete sealing and/or acoustic decoupling and/or high-strength connection of the shell and the structural component. The structural material used can be made of butyl rubber systems, which can be permanently plastic or are crosslinkable by heat input, or of EVA-based foams that expand as a result of heat input, or of thermally reactive structural adhesives or foams. In particular, structural materials of the kind mentioned exhaustively above are conceivable.

A further advantage is the use of an at least locally trough-shaped shell. Shells of this kind are particularly suitable for vehicle construction and appliance manufacture, since particularly stable shells can be furnished using comparatively little material. Shells having U- or V-shaped cross sections can be used in particular in this context. Also suitable are trough-shaped shells in the form of I-profiles or double-T-profiles, T-profiles, Z-profiles, or L-profiles, in which a space configured as a trough is at least partly delimited as governed by the profile shape.

It has proven particularly advantageous in this context to configure the structural component in such a way that it has, in its side facing toward the trough-shaped part of the shell, substantially the same trough-like shape as the trough-shaped part of the shell. It would accordingly be possible, when using a trough-shaped shell having a U-profile, to use a structural component that likewise has a U-profile, and that by preference is dimensioned in such a way that it can be placed in the space delimited by the shell.

It is particularly advantageous in this context to configure the structural component in such a way that it itself delimits a second trough-like shape, stiffening means being provided in order to reinforce the shell, and the stiffening means being provided in the second trough-shaped space of the structural component. It is possible in this context to use, in particular, stiffening ribs that extend from the one side of a wall portion of the structural component delimiting the second trough-shaped space to an oppositely located wall portion. The ribs can by preference be arranged in such a way that they extend in accordance with the forces expected to be acting on the shell and on the structural component, in order to supply optimum reinforcement and/or stiffening of the shell by way of the structural component. In addition, the stiffening means can be configured as reinforcing webs and/or reinforcing columns of various wall thicknesses that are designed with reference to the respective stress zones of the composite component. In this regard a zone having a higher expected stress would be equipped with thicker ribs, columns, or webs than zones having a lower expected stress.

A further advantage composite component is configuration of the structural component in such a way that it covers substantially the entirety of that part of the shell which delimits the space, in order to provide protection from environmental influences for the shell. The structural component accordingly, for example in the case of a shell having a U-profile, for example covers both the bottom region of the shell and the two wall regions that delimit the space. It is thus possible to prevent moisture, which collects in particular in the space in the case of, for example, vehicle columns, from coming into contact with the shell itself, so that corrosion can be avoided.

A further advantage is equipping the structural component with means for immobilizing an attached part. This has the particular advantage that in addition to reinforcement and/or stiffening of the shell by means of the structural component, a connecting or installation capability for further attached parts onto the shell can be supplied by way of the structural component. The means can be configured in particular as functional components such as holders, hooks, orifices for screw connections, or similar connecting elements known to the skilled artisan. Such components often represent a sensitive area for external influences, for example in the context of shells utilized in vehicle construction. The fact that these means are supplied on the structural component can allow a further protective capability for the shell to be supplied by way of the structural component.

A further advantage in the context of use of a shell of at least locally trough-shaped configuration is conformation of the structural component in such away that it at least locally covers the trough in such a way that a cavity is formed between the structural component and shell, and that at least one reinforcing means, which projects into the cavity in the direction of the shell, is provided on the structural component.

The use of a structural material that is in contact with the reinforcing means has furthermore proven advantageous.

The invention will be explained in further detail below with reference to exemplifying embodiments depicted in the drawings:

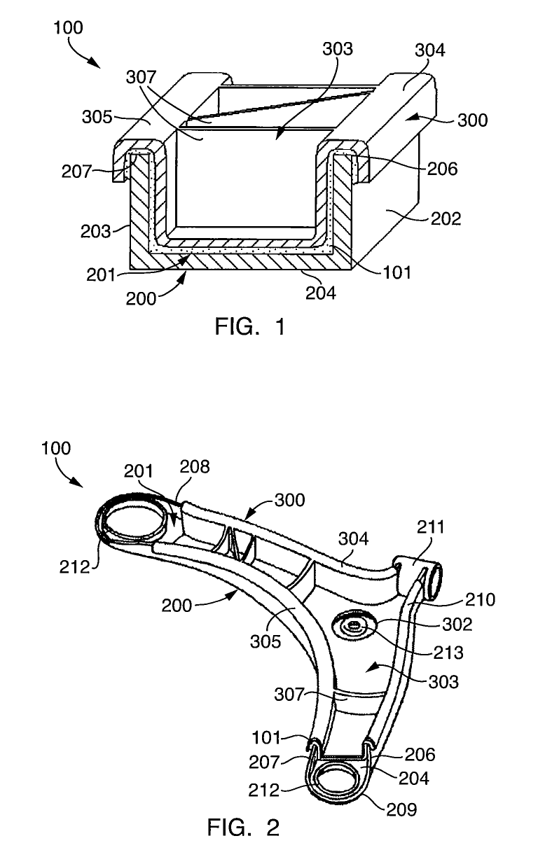

FIG. 1 is a perspective sectioned view of a composite component according to the present invention having a shell, a structural component, and an expandable structural material,

FIG. 2 is a perspective view of a composite component according to the present invention in the form of a transverse link of a motor vehicle,

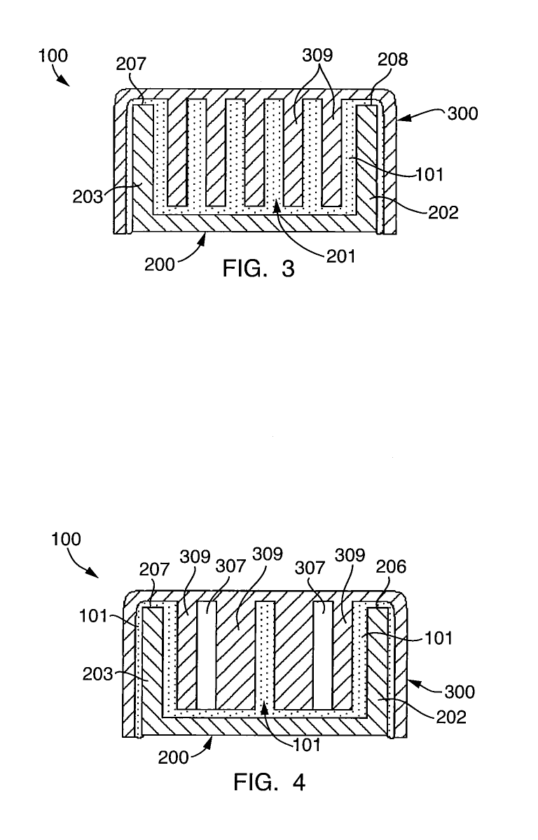

FIG. 3 is a sectioned view of an alternative composite component according to the present invention,

FIG. 4 is a sectioned view of a further alternative of a composite component according to the present invention,

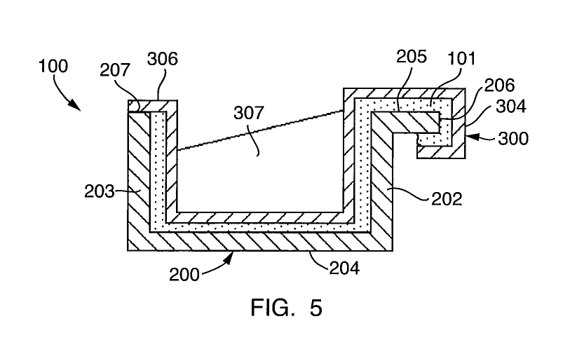

FIG. 5 is a sectioned view of a further alternative of a composite component according to the present invention.

FIG. 1 shows a composite component 100 having a trough-shaped shell 200 and a likewise trough-shaped structural component 300 placed into trough-shaped shell 200. In the sectioned view shown, shell 200 has a U-profile and contains a bottom 204, a first wall 202, and a second wall 203 that locally enclose a space 201. Structural component 300 provided in space 201 is arranged at a distance from bottom 204 and from walls 202, 203. Provided between structural component 300 and shell 200 is a gap that is filled with a structural material 101. In the present case this is a thermally expandable structural material 101 that is in the expanded state in the exemplifying embodiment shown, and on the one hand supplies immobilization of structural component 300 on shell 200, and on the other hand fills up the gap between structural component 300 and shell 200 in such a way that, in particular, dirt and moisture cannot get into the gap. To improve the adhesion of structural material 101, the surface in particular of structural component 300 can be finished with a high degree of roughness. The surface of shell 200 can be similarly configured or processed.

The two walls 202, 203 terminate, at their ends facing away from bottom 204, in a first free edge 206 resp. a second free edge 207. Structural component 300 is configured in such a way that it extends in trough-shaped space 201 over bottom 204 and over walls 202, 203, and by means of a first wraparound 304 covers first free edge 206 in wraparound fashion and in fact partly overlaps the outer surface of first wall 202. Structural component 300 furthermore comprises a second wraparound 305 with which it covers second end 207 in wraparound fashion and, on this side as well, locally overlaps the outer surface of side wall 203. In the region of wraparounds 304, 305 as well, structural component 300 is arranged at a distance from shell 200, structural material 101 being provided in the gap thus supplied so that the two free edges 206, 207 in particular are protected from external influences and in particular from corrosion.

Wraparounds 304, 305 have the advantage that the stiffening performance of the reinforcing inner element of structural component 300 can be enhanced, while at the same time edges 206, 207 of side walls 202, 203 of shell 200 can be additionally protected from corrosion. At the same time, in the context of external applications such as, for example, use of shell 202 as a subframe, transverse link, or other attached parts, in particular in vehicle construction, the influence of aging as a result of environmental conditions can also be reduced.

The present exemplifying embodiment refers to a shell 200 made of a metallic material and a structural component 300 made of a polyamide, which prior to assembly with shell 200 was equipped with structural material 101 in an unexpanded state. After assembly of structural component 300 and shell 200, structural material 101 was expanded in order to effect immobilization between the two components 200, 300. The result of such an arrangement is to provide a particularly strong composite component 100 such that structural component 300 reinforces shell 200. It is thereby possible to utilize a shell 200 that, as a result of the reinforcement by way of structural component 300, can be manufactured to have the same or even improved strength using less material. By means of the planar covering of walls 202, 203 and of bottom 204 with structural component 300, and in particular by means of the at least local extension of structural component 300, via its wraparounds 304, 305, over free edges 206, 207, it is furthermore possible to supply a protection capability for shell 200 and in particular for free edges 206, 207.

FIG. 2 is a perspective view of a reinforced composite component 100 according to the present invention that is used as a transverse link for a motor vehicle. Here as well, composite component 100 is made up of a shell 200, used as a shell element, that comprises three limbs 208, 209, 210. Two eyelets 212, for the reception of ball joints (not shown), are provided on limbs 208, 209. Limb 210 in turn comprises a sleeve 211, for example for a rubber bearing (not depicted). Here as well, shell 200 encloses locally a trough-shaped space 201 having a bottom 204. The space is further delimited by two walls that comprise two free edges 206, 207. Structural component 300, which is configured in such a way that it can be placed into trough-shaped space 201 and connected to shell 200 by means of a structural material 101, is used here to reinforce the transverse link. Structural component 300 is for its part likewise trough-shaped, and at least locally determines space 303. The base shape of structural component 300 corresponds substantially to the base shape of shell 200. Structural component 300 is configured in such a way that it comprises two wraparounds 304, 305 that cover free edges 206, 207 of shell 200 in wraparound fashion. To reinforce shell 200 and to protect free edges 206, 207, the gap between wraparounds 304, 305 and free edges 206, 207 is filled with a structural material 101.

Structural component 300 is furthermore equipped with an opening 302 through which portions of bottom 204 are exposed and, in the present exemplifying embodiment, a collar 213 protrudes, on which collar further components can be connected to the transverse link. Here as well, multiple stiffening ribs 307 that extend through space 303 of reinforcing component 300 are provided for further reinforcement. Because shell 200, utilized as a transverse link, is equipped with the structural component 300 shown, a reinforced composite component 100 can be supplied. Forces acting on shell 200 can be absorbed by structural component 300 thanks to the immobilization of structural component 300 on shell 200 via structural material 101. Stiffening ribs 307 are provided for this, in particular in highly loaded regions. In addition, shell 200 can be protected from external influences, in particular from corrosion, by the fact that large areas of the walls and of bottom 204 are covered by structural component 300. In addition, structural component 300 supplies an additional protective capability for free edges 206, 207 of shell by way of wraparounds 304, 305.

FIG. 3 is a sectioned view of a further composite component 100 according to the present invention having a U-shaped shell 200 at least locally surrounding a trough-shaped space, and a structural component 300 placed on it. Structural component 300 is configured as a lid structure so that it covers space 201, free edges 206, 207, and the outer regions of walls 202, 203. Structural component 300 is arranged at a distance from shell 200, structural material 101 being provided in the gap. Immobilization of structural component 300 on shell 200, and sealing of the gap between structural component 300 and shell 200, can thereby be supplied. In addition, a configuration of this kind can also ensure galvanic isolation between structural component 300 and shell 200, as may be necessary, for example, in vehicle construction, in particular when structural component 300 and shell 200 are made of a metallic, electrically conductive material.

For further reinforcement of shell 200, structural component 300 comprises reinforcing means 309 projecting into space 201, which in the exemplifying embodiment shown are of cylindrical configuration. It is evident from the sectioned view that structural component 300 comprises a plurality of reinforcing means 309 that are arranged next to one another and are at a distance from one another, structural material 101 once again being provided in the gap, in particular, between reinforcing means 309.

FIG. 4 is a sectioned view of a further embodiment of a reinforced composite component 100 according to the present invention. Here as well, a shell 200 having a U-profile is used, and structural component 300 covers space 201, free edges 206, 207, and the outer surfaces of walls 202, 203. Here as well, structural material 101 is provided, for immobilization and for sealing, in the gap between structural component 300 and shell 200.

As in the case of composite component 100 shown in FIG. 3, structural component 300 used here also comprises a plurality of reinforcing means 309 projecting into the space, which in the exemplifying embodiment shown have different dimensions and diameters. Here as well, reinforcing means 309 are arranged at a distance from one another. Some of the reinforcing means 309, however, are connected to one another via reinforcing means 307. Other reinforcing means 309 in turn are merely arranged at a distance from one another, structural material 101 being arranged in the gap between said reinforcing means 309. It is possible in this manner to provide a particularly strong composite component 100 that is moreover, because of the particular shape of structural component 300, protected from external influences and from corrosion.

FIG. 5 is a sectioned view of a further embodiment of a structural component 100 according to the present invention. Here as well, shell 200 that is used has as its basic shape a U-profile, such that wall 202 bends over at a right angle on its side facing away in terms of bottom 204, and comprises a planar end region 205 that extends parallel to bottom 204 and terminates in free edge 206. The opposite wall 203, which terminates in free edge 207, has a planar shape. In the instance shown, structural component 300 that is used is configured in such a way that it covers the inner sides of walls 202, 203 and of bottom 204; here as well, a gap is provided which is filled with the structural material. In the region of free edge 207, structural component 300 comprises a covering 306 that covers the end surface of wall 203, i.e. free edge 207, but is not embodied in wraparound fashion, i.e. does not cover an outer side of wall 203. In addition, no gap is provided between covering 306 and free edge 207. Instead, structural component 300 rests with covering 306 directly on free edge 207.

On the opposite side, the structural component is adapted to the shape of wall 202 and contains a covering for end region 205 and a wraparound 304 for free edge 206. Here structural component 300 is arranged at a distance from shell 200, structural material 101 once again being provided in the gap. Structural component 300 is of trough-shaped configuration in the region of the covering of the inner sides of walls 202, 203 and of bottom 204, and a reinforcing means 307 is provided which extends obliquely over the trough from the one side, delimiting the trough, of structural component 300 to the other side.

In general, in all the embodiments shown, the stiffening and reinforcing performance of structural component 300 can be adjusted by suitable selection and design of stiffening means 307 and reinforcing means 309. It is conceivable in this context to use these means 307, 309 in particular as reinforcing or stiffening webs, ribs, or columns of different wall thicknesses based on the respective stress zones of component 100 as a whole, zones of higher stress being equipped with thicker ribs, columns, or webs.

The columns, in particular, that are used can in general be hollow ones that can be arranged obliquely or perpendicularly with respect to the longitudinal axis of shell 200 and can be built up from a closed or open circular, ellipsoidal, or other non-angular contour. Columns can moreover be arranged parallel to the longitudinal axis of shell 200 and can then be attached as a tube, half-open to the outside, for reinforcement in an axial direction. Columns in or perpendicular to the longitudinal axis can be entirely or partly filled with structural adhesive or structural foam. Columns can have different diameters and can be arranged so that contact points of the outer walls 202, 203 of each four round columns form a rectangle or two triangles. Columns can also, as shown in FIG. 3, be arranged without touching, i.e. can be freestanding, or as shown in FIG. 4 can be connected via webs.

In addition, consideration can also be given to providing, in the direction of the longitudinal axis of shell 200, parallel to the longitudinal axis of shell 200 on the surfaces of structural component 300 that are covered with structural material 101, ribs that are embedded into structural material 101. In the context of a perpendicular principal direction of energy transfer into composite component 100, these ribs can be oriented perpendicularly, or at another angle, with respect to the longitudinal axis, conforming to said angles. In particular, ribs or webs can be embodied in corrugated fashion. The wall thicknesses in particular of webs, columns, or ribs are by preference within the range from 1 mm to 20 mm.

### LIST OF REFERENCE CHARACTERS

100 Composite component

101 Structural material

200 Shell

201 Space

202 First wall

203 Second wall

204 Bottom

205 End region

206 First free edge

207 Second free edge

208 First limb

209 Second limb

210 Third limb

211 Sleeve

212 Eyelet

213 Collar

300 Structural component

301 Wall

302 Opening

303 Space

304 First wraparound

305 Second wraparound

306 Covering

307 Stiffening ribs

308 Portion

309 Reinforcing means

What is claimed is:

1. A composite component (100) having a shell (200) at least locally peripherally delimiting a space (201), and having a structural component (300) to reinforce the shell (200), where the structural component (300) is arranged at least locally at a distance from a wall (202, 203, 204), determining the space (201), of the shell (200), where a structural material (101) is provided at least locally between the wall (202, 203, 204) of the shell (200) and the structural component (300),
wherein the shell (200) comprises at least one free edge (206, 207); and the structural component (300) extends at least locally over the free edge (206, 207) of the shell (200).

2. The composite component (100) according to claim 1, wherein at least one wall (202, 203), determining the space (201), of the shell (200) comprises the free edge (206, 207).

3. The composite component (100) according to claim 1, wherein the structural component (300) extends in wraparound fashion over the free edge (206, 207) of the shell (200) in order to completely cover it at least locally.

4. The composite component (100) according to claim 3, wherein the wraparound region of the structural component (300) is arranged at least locally at a distance from the free edge (206, 207), where a structural material (101) is provided at least locally between the structural component (300) and the free edge (206, 207).

5. The composite component (100) according to claim 1, wherein an at least locally trough-shaped shell (200) is used.

6. The composite component (100) according to claim 5, wherein the structural component (300) has, in its side facing toward the trough-shaped part of the shell (200), substantially the same trough-like shape as the trough-shaped part of the shell (200).

7. The composite component (100) according to claim 6, wherein the structural component (300) itself peripherally delimits a second trough-shaped space (303), wherein stiffening means (307) are provided in order to reinforce the shell (200), wherein the stiffening means (307) are provided in the trough-shaped space (303).

8. The composite component (100) according to claim 5, wherein the structural component (300) covers the space (201) of the shell (200) at least locally in such a way that a cavity is formed between the structural component (300) and shell (200); and at least one reinforcing means (309), which projects into the cavity in the direction of the shell (200), is provided on the structural component (300).

9. The composite component (100) according to claim 8, wherein at least one structural material (101) that is in contact with the reinforcing means (309) is provided.

10. The composite component (100) according to claim 1, wherein the structural component (300) covers substantially the entire part of the shell (200) delimiting the space (201), in order to supply protection from environmental influences for the shell (200).
